(19) United States
(12) Patent Application Publication
(10) Pub. No.: US 2018/0189422 A1
(43) Pub. Date: Jul. 5, 2018

(54) METHOD AND SYSTEM FOR AUTOMATICALLY GENERATING AN INTERIOR TESTFIT FOR A BUILDING

(71) Applicant: Aditazz, Inc., Brisbane, CA (US)

(72) Inventors: Robert Yu, Fremont, CA (US); Zigmund Rubel, Brisbane, CA (US); Sudha Hajela, Brisbane, CA (US); Chuck Han, San Francisco, CA (US); Suhas Belgal, Brisbane, CA (US)

(73) Assignee: Aditazz, Inc., Brisbane, CA (US)

(21) Appl. No.: 15/395,162

(22) Filed: Dec. 30, 2016

(51) Int. Cl. G06F 17/50

(52) U.S. Cl. CPC G06F 17/5004

(57) ABSTRACT

In accordance with an embodiment of the invention, an interior test fit system for automatically creating floor plan layouts is disclosed. The interior test fit system uses a computer having a memory, a central processing unit, and a display, the memory containing instructions that, when executed by the central processing unit, perform steps comprising obtaining client parameters, a room library, and a tile library as inputs, determining a set of selected rooms from the room library, the set defined as a function of room contents and client parameters, determining a set of selected tiles from the tile library, the set defined as a function of tile designs and the room attributes of the set of selected room, and determining a placement of the set of tiles within a floor plan layout, the placement defined as a function of tile attributes of the selected tiles and building shell attributes.

### BACKGROUND

Buildings are an integral part of everyday life. The process of planning, designing, and constructing buildings has evolved over several thousands of years. Today, the steps followed to physically realize modern buildings are very complicated and require a high degree of skilled labor that can span several different disciplines. This complexity poses a huge challenge in terms of time, money, and other resources expended in order to build a viable facility that can be used to deliver the intended services in an efficient and profitable way.

### SUMMARY

In an embodiment, an interior test fit system for automatically creating floor plan layouts is disclosed. The interior test fit system uses a computer having a memory, a central processing unit, and a display, the memory containing instructions that, when executed by the central processing unit, perform steps comprising obtaining client parameters, a room library, and a tile library as inputs, determining a set of selected rooms from the room library, the set defined as a function of room contents and client parameters, determining a set of selected tiles from the tile library, the set defined as a function of tile designs and the room attributes of the set of selected room, and determining a placement of the set of tiles within a floor plan layout, the placement defined as a function of tile attributes of the selected tiles and building shell attributes.

In a second embodiment, client parameters define a percentage of the floor plan layout to be occupied by at least one mode.

In another embodiment, the function of room contents and client parameters is a function such that the total percentage of area in the set of selected rooms allocated to at least one mode is equal to or greater than the total percentage of floor plan area to be allocated to the at least one mode as defined by the client parameters.

In another embodiment, the function of tile designs and the room attributes of the set of selected rooms is a function such that all of the rooms in the space program can be placed within tiles in the set of selected tiles given the tile designs of the selected tiles and the selected tiles can be arranged in a manner which satisfies circulation constraints.

In another embodiment, the function of tile attributes of the selected tiles and building shell attributes is a function such that the selected tiles do not overlap while placement requirements are satisfied.

In another embodiment, a method for automatically creating floor plan layouts is disclosed. In an embodiment, the method involves obtaining client parameters, a room library, and a tile library as inputs, determining a set of selected rooms from the room library, the set defined as a function of room contents and client parameters, determining a set of selected tiles from the tile library, the set defined as a function of tile designs and the room attributes of the set of selected room, and determining a placement of the set of tiles within a floor plan layout, the placement defined as a function of tile attributes of the selected tiles and building shell attributes.

In another embodiment, obtaining client parameters comprises defining a percentage of the floor plan layout to be occupied by at least one mode.

In another embodiment, the function of room contents and client parameters is a function such that the total percentage of area in the set of selected rooms allocated to at least one mode is equal to or greater than the total percentage of floor plan area to be allocated to the at least one mode as defined by the client parameters.

In another embodiment, the function of tile designs and the room attributes of the set of selected rooms is a function such that all of the rooms in the space program can be placed within tiles in the set of selected tiles given the tile designs of the selected tiles and the selected tiles can be arranged in a manner which satisfies circulation constraints.

In another embodiment, the function of tile attributes of the selected tiles and building shell attributes is a function such that the selected tiles do not overlap while placement requirements are satisfied.

In another embodiment, a non-transitory computer-readable storage medium is disclosed. In an embodiment, the non-transitory computer-readable storage medium stores instructions that, when executed by a computer, cause the computer to perform steps for creating floor plan layouts, the steps involving obtaining client parameters, a room library, and a tile library as inputs, determining a set of selected rooms from the room library, the set defined as a function of room contents and client parameters, determining a set of selected tiles from the tile library, the set defined as a function of tile designs and the room attributes of the set of selected room, and determining a placement of the set of tiles within a floor plan layout, the placement defined as a function of tile attributes of the selected tiles and building shell attributes.

In another embodiment, obtaining client parameters comprises defining a percentage of the floor plan layout to be occupied by at least one mode.

In another embodiment, the function of room contents and client parameters is a function such that the total percentage of area in the set of selected rooms allocated to at least one mode is equal to or greater than the total percentage of floor plan area to be allocated to the at least one mode as defined by the client parameters.

In another embodiment, the function of tile designs and the room attributes of the set of selected rooms is a function such that all of the rooms in the space program can be placed within tiles in the set of selected tiles given the tile designs of the selected tiles and the selected tiles can be arranged in a manner which satisfies circulation constraints.

In another embodiment, the function of tile attributes of the selected tiles and building shell attributes is a function such that the selected tiles do not overlap while placement requirements are satisfied.

Other aspects and advantages of embodiments of the present invention will become apparent from the following detailed description taken in conjunction with the accompanying drawings.

### BRIEF DESCRIPTION OF THE DRAWINGS

FIG. 1 is an example illustration of a floor plan layout.

FIG. 2 is a flow chart diagram that illustrates a floor plan layout process using an exemplary embodiment of an interior test fit system.

FIG. 3 is an example illustration of a portion of a room library.

FIG. 4 is an example illustration of an interface for collecting client parameters.

FIG. 5 is an example illustration of a space program generated by a space program generator.

FIG. 6A is an example of a tile library table.

FIG. 6B is an example illustration of a portion of a tile library.

FIG. 7 is an example illustration of a set of selected tiles.

FIG. 8 is an example illustration of a list of variables corresponding to a set of selected tiles.

FIG. 9 is an illustration of a building shell.

FIG. 10 depicts a computer that includes a processor, memory, and a communications interface.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

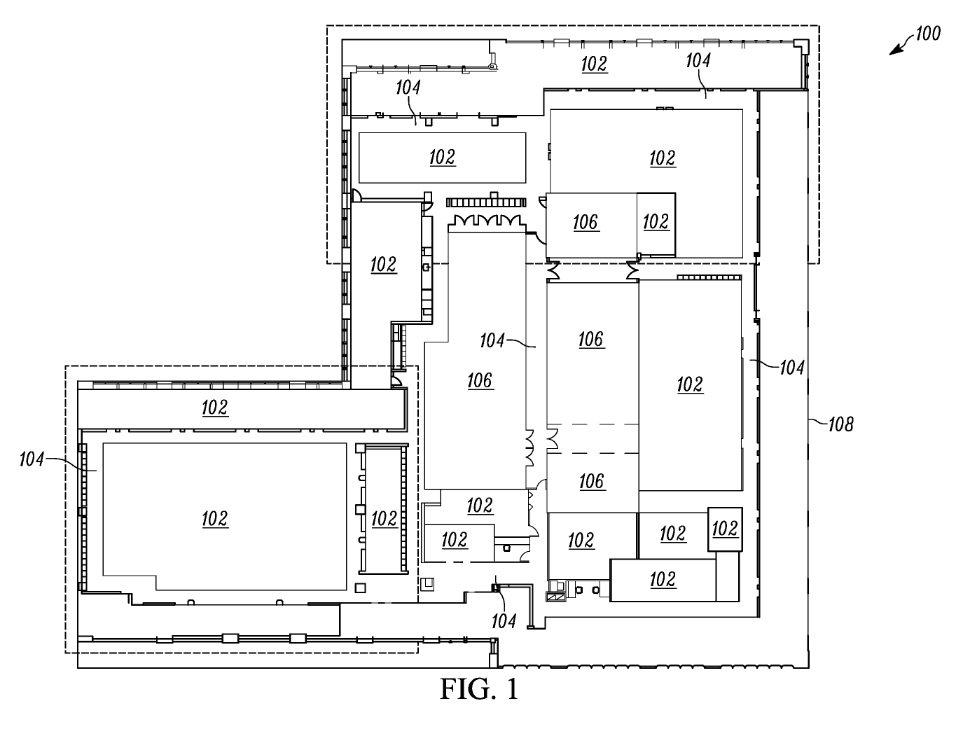

FIG. 1 is an example illustration of a floor plan layout 100 of a building. A floor plan layout of a building can be a bird's eye view or a 3D model of a floor plan layout and can include the location of rooms 102, the pattern of hallways 104 or circulation through the floor plan, the core 106 of a building, and the building shell 108 as well as other information about the layout of a floor plan. Traditionally, a floor plan layout is a drawing produced by hand by an architect. The architect receives a description of what is needed from a client and creates drawings of a floor plan layout based on the client description. Creating drawings of floor plan layouts by hand can be a time consuming and skill-intensive task. Accordingly, the architect typically only creates two to four drawings of floor plan layouts from which the client is faced with the decision of selecting the best option. Due to the complexity of drawing the floor plan layouts, it is not uncommon that one or more of the created drawings does not satisfy client needs due to, for example, the omission of needed features or the failure to initially understand client needs. Additionally, the needs of the client may change during the building design process and, if the architect is notified too late or not at all, the floor plan layout may fail to satisfy the changed client needs. In the event that none of the drawings of floor plan layouts satisfy the client needs, the architect may need to create additional drawings of floor plan layouts, at what is often a significant expense to the client.

In accordance with an embodiment of the invention, a computer-implemented interior test fit system for automatically creating floor plan layouts is disclosed. The interior test fit system uses a computer having a memory, a central processing unit, and a display, the memory containing instructions that, when executed by the central processing unit, perform steps including obtaining client parameters, a room library, and a tile library as inputs, determining a set of selected rooms from the room library, the set defined as a function of room contents and client parameters, determining a set of selected tiles from the tile library, the set defined as a function of tile designs and the room attributes of the set of selected room, and determining a placement of the set of tiles within a floor plan layout, the placement defined as a function of tile attributes of the selected tiles and building shell attributes. That is, the interior test fit system allows for the automated creation of a floor plan layout. The interior test fit system, using a constraint solver, can automatically generate a floor plan layout that satisfies client needs or can determine if such a floor plan layout is not possible (e.g., a “testfit”). Additionally, if the client needs change or if the automatically generated floor plan layout is otherwise unsatisfactory to the client, the client parameters can be changed and a new floor plan layout can be automatically generated (e.g., a new “testfit”) in a quick and efficient manner without the need for an architect to create new drawings by hand.

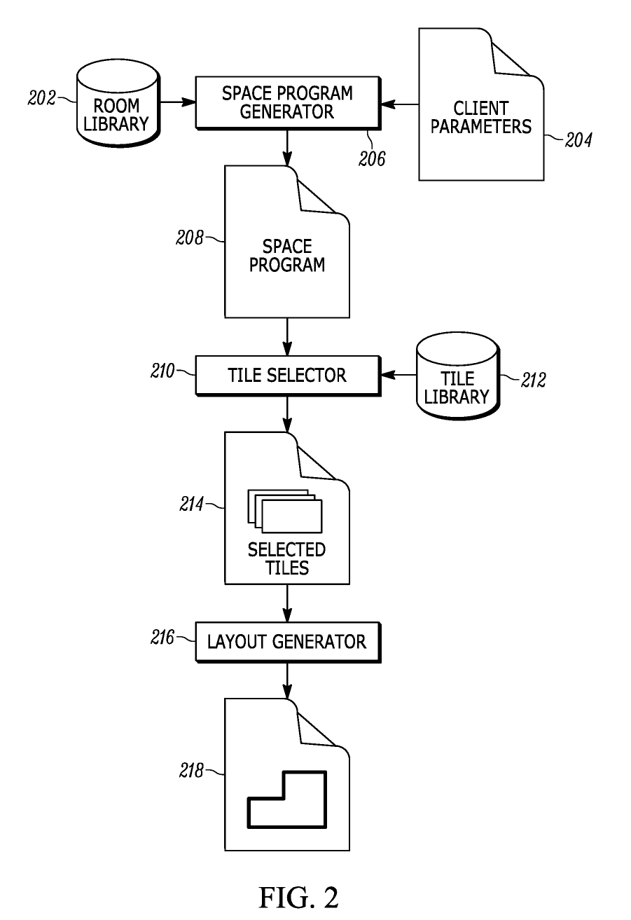

While, traditionally, a floor plan layout is created by an architect by hand, the interior test fit system creates a floor plan layout using rules applied to defined inputs. FIG. 2 is a flow chart diagram that illustrates a floor plan layout process using an exemplary embodiment of an interior test fit system. With reference to FIG. 2, components of the interior test fit system will be introduced for further detailed description within. In the embodiment of FIG. 2, the interior test fit system includes three engines: a space program generator 206, a tile selector 210, and a layout generator 216. In an embodiment, the space program generator 206 receives a room library 202 and client parameters 204 as inputs, and generates a space program 208 that defines the type and number of rooms to be placed in a floor plan layout. In an embodiment, the space program is defined as a function of room contents (e.g., desks, conference tables, networking equipment) and client parameters (e.g., percent of floor space needed for workspaces). The space program is then passed to the tile selector 210 along with a tile library 212. The tile selector generates a set of selected tiles 214 and the selected tiles are passed to the layout generator 216. In an embodiment, the set of selected tiles is generated as a function of tile designs and the room attributes of rooms in the space program. The layout generator determines a placement of the set of tiles within a floor plan layout 218 as a function of tile attributes of the selected tiles and building shell attributes. In an embodiment, a placement defines where one or more of the selected tiles are placed within a building shell.

Room Library

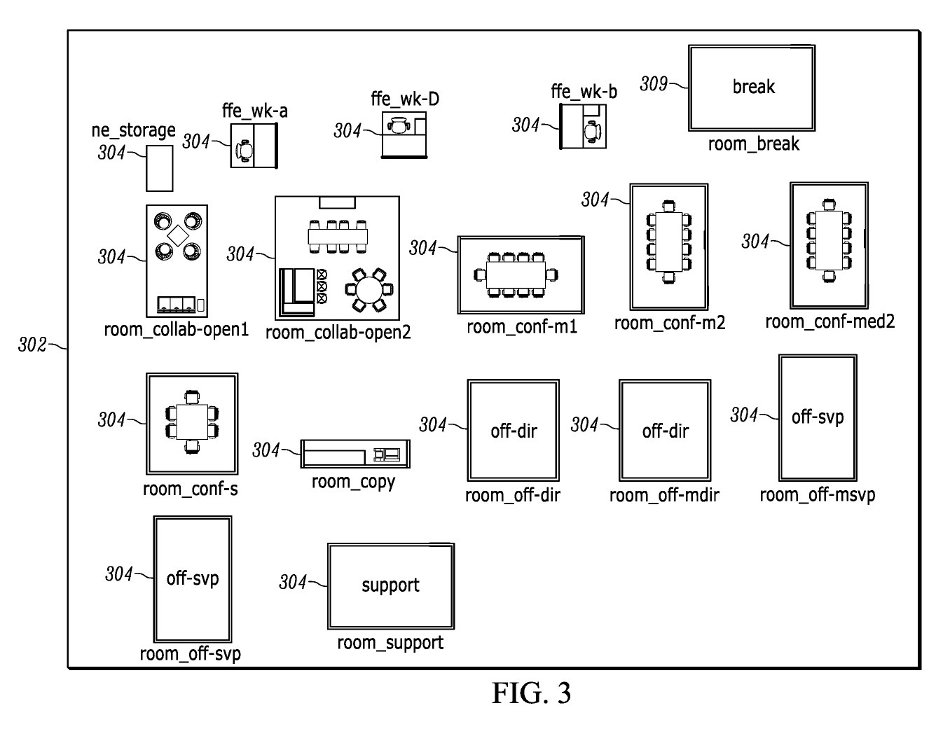

FIG. 3 is a graphical representation of a portion of a room library 302. The portion of the room library includes several room designs 304. In operation, the room library may be a file containing a list of room designs described in attribute-value pairs (e.g., in JavaScript Object Notation (JSON) or Extensible Markup Language (XML)). The file may include information about at least one room design. For example, an entry for a room design in the file may include information indicating that a room is a conference room and has a set of physical dimensions (e.g., width, length, and height) and ranges around the dimensions (e.g., 10 ft wide plus or minus 2 feet). In FIG. 3, the example includes a room design “ne_storage,” which is a network equipment storage room, “ffe_wk-a,” which is a type-a workspace, “ffe_wk-d,” which is a type-d workspace, “ffe_wk-b,” which is a type-b workspace, “room_break,” which is a break room, “room_collab-open1,” which is a type of open collaboration space, “room_collab-open2,” which is a type of open collaboration space, “room_conf-m1,” which is a type of conference room, “room_conf-m2,” which is a type of conference room, “room_conf-med2,” which is a type of medium-sized conference room, “room_conf-s,” which is a type of small-sized conference room, “room_copy,” which is a copying equipment storage room, “room_off-dir,” which is a type of director office, “room_off-mdir,” which is a type of director office, “room_off-msvp,” which is a type of director office, “room_off-svp,” which is a type of director office, and “room_support,” which is an area for office support personnel.

Client Parameters

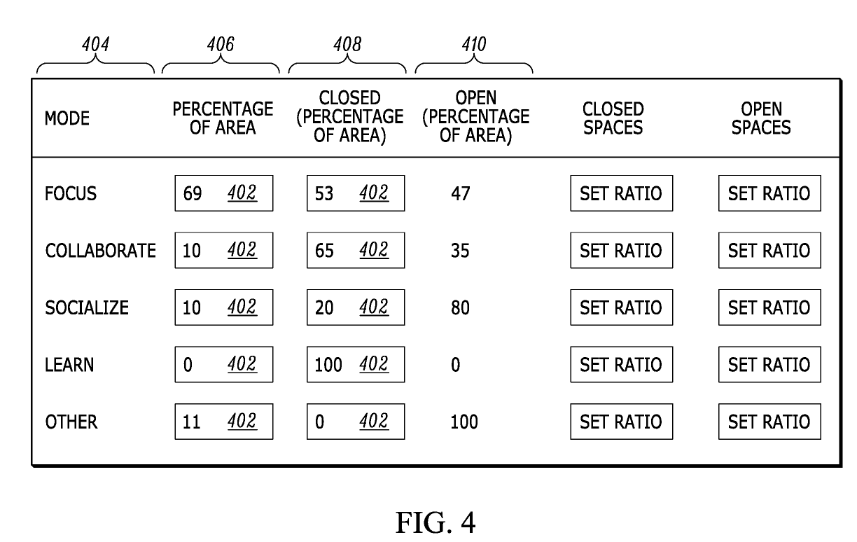

FIG. 4 is an example illustration of an interface for collecting client parameters. In the example illustrated by FIG. 4, the client parameters relate to the function or mode of space in the floor plan layout. As illustrated, the interface is formed by input boxes 402 arranged in a series of columns and rows. The rows 404 corresponds to a mode or purpose to be achieved by space within a floor plan. For example, the modes in FIG. 4 include “focus,” “collaborate,” “socialize,” “learn,” and “other,” which generally define certain functions of the corresponding space. The columns associated with a row correspond to the percentage of area of a floor plan layout to be occupied by the corresponding mode 406, a percentage of that area to be closed 408 (e.g., walled space such as an office or conference room), and a percentage of that area to be open 410 (e.g., space without walls such as workstations or lounge areas). The closed spaces

“Set Ratio” buttons 412 open a sub-menu in which a ratio of rooms to be included can be set (e.g., for every two director offices, include three manager offices and one senior vice president office). The data entered into the input boxes can be converted into constraint statements for use by the space program generator. For example, the “69” entered into the input box for the percentage of area to be allocated to a particular mode can be converted into a constraint statement that states that the set of rooms selected must have a combined 69% of space allocated to the “focus” mode. In an embodiment, the client parameters can indicate a percentage of the floor plan layout to be allocated for several modes as well as a percentage of the floor plan layout allocated to be open or closed.

Space Program Generator

In an embodiment, a space program generator evaluates a function which takes a room contents (e.g., a portion of information stored in a room library) and client parameters as inputs and determines a set of rooms from the room library that will satisfy the client parameters for a given floor plan. For example, the space program generator receives a room library and client parameters, which state that 69% of the floor plan layout should be “focus” type space. The space program generator can add focus-type rooms to a set of selected focus-type rooms and evaluate a function that divides the area of the selected focus-type rooms by the total available space in a floor plan layout until the set of selected focus-type rooms is equal or greater than to 69% of the floor plan layout.

Space Program

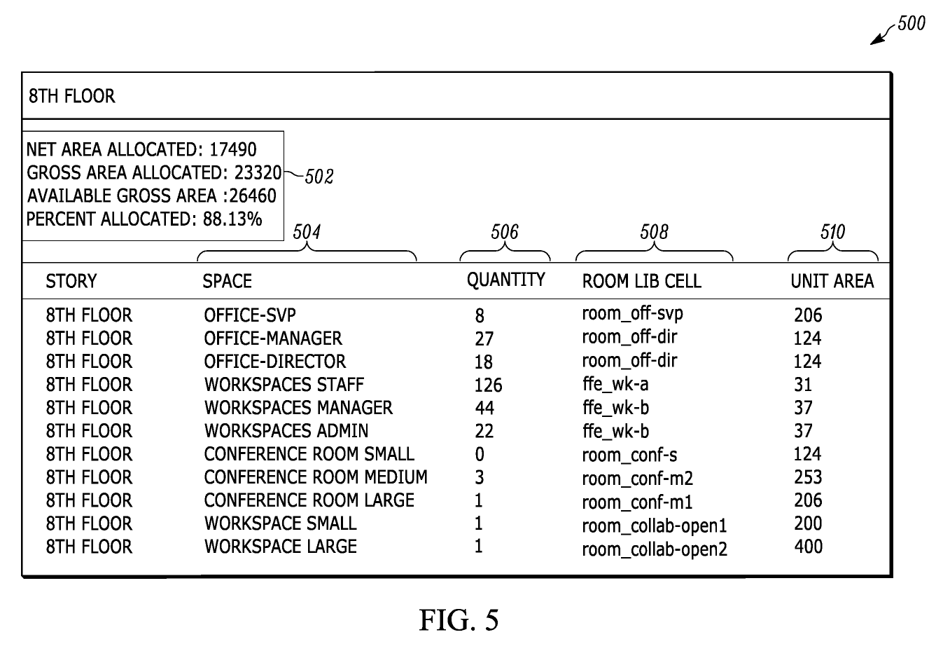

FIG. 5 is an example illustration of a space program 500 generated by the space program generator. The space program indicates the dimensions of the floor plan layout 502, which includes the net area allocated, the gross area, the available gross area, and the percent of space in the floor plan that is allocated. The space program also indicates the types of rooms or spaces to be placed 504, the quantity of a type of space to be placed 506, a variable name for the type of space to be placed 508, and an amount of area occupied by the type of space to be placed 510. For example, the space program includes eighteen “Office-Director” spaces, which take up a collective 124 square meters of the floor plan.

Tile Library

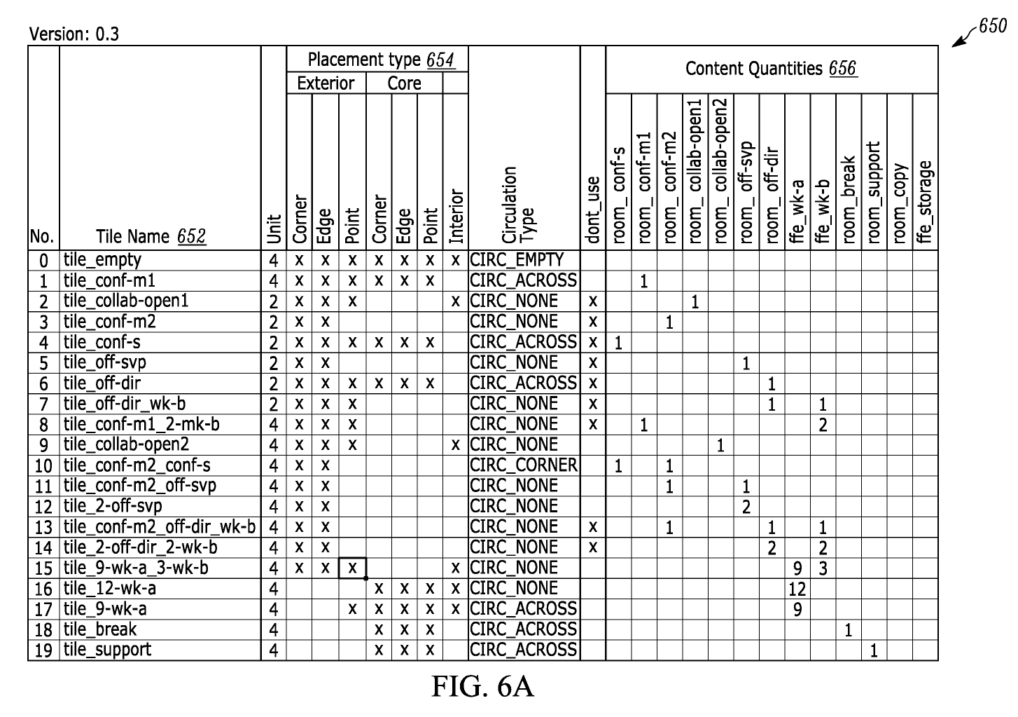

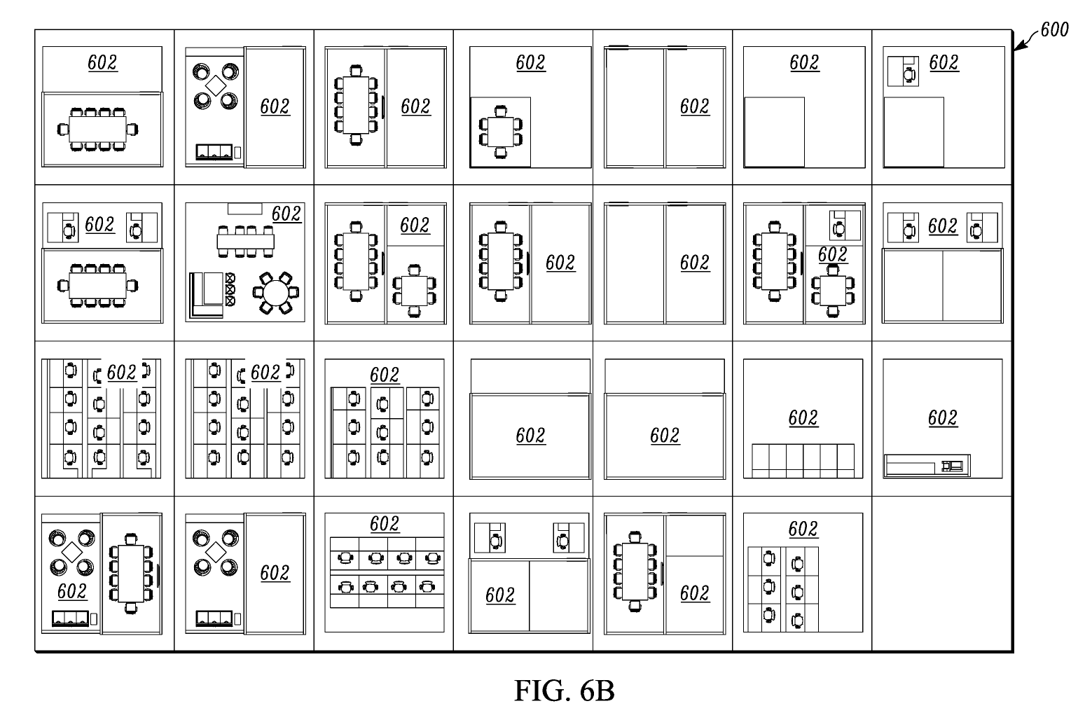

In an embodiment, the tile library is a database of tile designs. Additionally, the database may include information about the tile designs. For example, a tile design may include information indicating a preplaced combination of rooms on the tile, the physical dimensions (e.g., width, length, and height) and ranges around the dimensions (e.g., 10 ft wide plus or minus 2 feet) of the tile design, the presence and positioning of circulation elements on a tile design or other tile design characteristics. In an embodiment, the tile library can be read in from a table file as illustrated in FIG. 6A. The table 650 may include information such as names of tile 652, placement types 654 for the tiles that indicate where on a floor plan a tile can be placed, and content quantities 656 for the tiles that indicate the number of rooms included in a particular tile.

FIG. 6B is an example illustration of a portion of a tile library 600. As illustrated, a tile design 602 may include one or more preplaced rooms and/or circulation elements. A preplaced room can include room elements (e.g., a conference table and chairs or a cubicle). In another embodiment, a tile design can be defined as a shape with circulation elements, but without any rooms placed.

Tile Selector

As described above with reference to FIG. 2, the space program and the tile library are passed as inputs to the tile selector (210, FIG. 2) and the tile selector generates a set of selected tiles from a tile library as a function of tile designs and the room attributes of rooms in the space program. In an embodiment, the tile selector is implemented with a constraint programming solver (sometimes referred to simply as a “constraint solver”). The constraint programming solver can be one of several publicly available constraint programming solvers, such as OR-Tools or Opturion CPX. As described above with reference to FIG. 2, the constraint programming solver receives the space program and the tile library. In an embodiment, a constraint programming language, such as MiniZinc, can be used to express attributes of rooms in the space program and designs of tiles in the tile library. In an embodiment, room attributes include attributes such as the number of bays a room occupies or a proximity requirement to another room (e.g., break room next to storage). In an embodiment, tile designs include design elements such as the number of bays a tile occupies, physical dimensions of the tile, or the arrangement of circulation elements within the tile. The constraint programming solver selects tiles from the tile library by solving for a set of selected tiles that can accommodate the space program. In an embodiment, a set of selected tiles can accommodate a space program if all of the rooms in the space program can be placed within tiles in the set of selected tiles given the tile designs of the tiles in the set of selected tiles. For example, if the space program includes six desk rooms and a desk room occupies one bay, then a set of selected tiles will accommodate the space program if at least a cumulative six bays are included in the tile designs of the set of selected tiles. Additionally, a set of selected tiles that can accommodate a space program may also satisfy circulation constraints (e.g., where hallways are located within a tile).

In order to solve for the set of selected tiles, in addition to the space program and the tile library, the constraints programing solver may also receive user inputs, knowns, unknowns, and constraints as inputs. User inputs may include variables such as, for example, a list of tiles to at least include in the floor plan (e.g., a base selection), a number of bays or units available in a floor plan, a count equal to an upper range of tiles to include in a floor plan (e.g., a single value or a range), or target areas for at least one mode (e.g., 69% of the space in the selected tiles must provide focus space). Knowns may include variables such as, for example, the types of tiles in the tile library, the modes of the tiles in the library, the number of bays or units occupied by a tile, or circulation elements within tiles in the tile library. Unknowns may include variables such as, for example, a count of the types of tile to include in the floor plan layout, a count of the room types to include in the floor plan layout, and an area of the floor plan layout allocated to at least one mode. Constraints can include constraint programming statements that, for example, limit the solution to a set of tiles comprising a count of tiles equal to or less than the upper range of tiles to include in the floor plan, or a constraint programming statement that limits the solution to a set of tiles that includes at least the base selection of tiles.

Selected Tiles

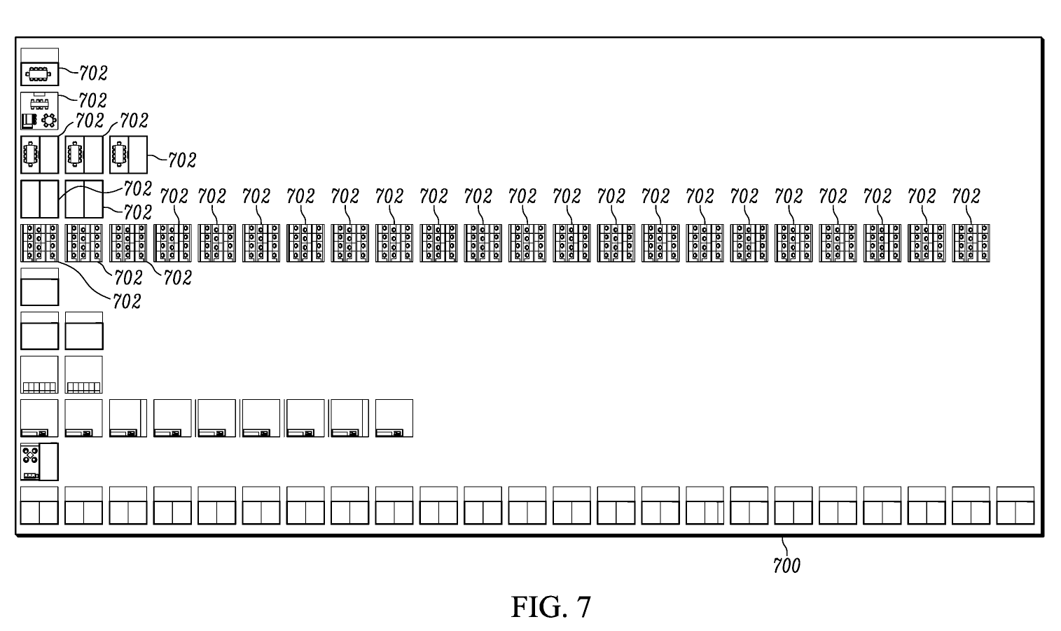

FIG. 7 is an example illustration of a set of selected tiles 700. As illustrated, the set of selected tiles is a selection of tiles from the tile library and a tile 702 is populated with a number of rooms. While the tiles are selected for placement in the floor plan layout, the selected tiles do not have placement information that indicates where or how the tile is placed in a building shell. Because the tiles do not have placement information, the selected tiles can be output as elements in rows, as illustrated.

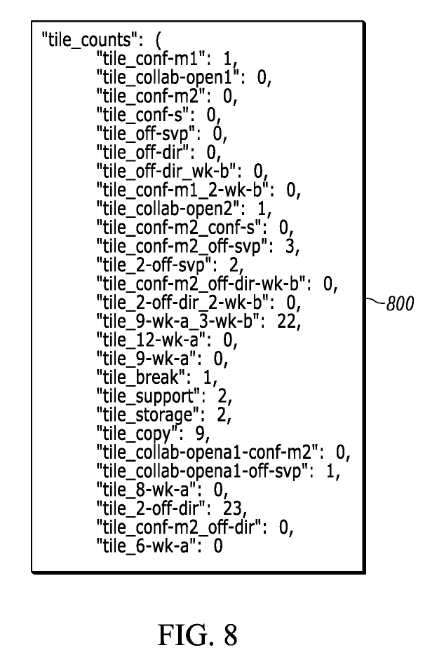

Alternatively, the set of selected tiles can be output as a list 800 of variables and an associated count. FIG. 8 is an example illustration of a list of variables corresponding to a set of selected tiles. As illustrated, the list is an array of ordered pairs in which a pair is a variable corresponding to a tile and a count corresponding to the number of occurrences of that tile in the floor plan layout. For example, “‘tile_conf-m1’: 1” indicates one conference room tile in the set of selected tiles and “‘tile_collab-open1’: 0” indicates zero open collaboration spaces in the set of selected tiles. Similar to FIG. 7, the list of variables still does not have placement information.

Building Shell

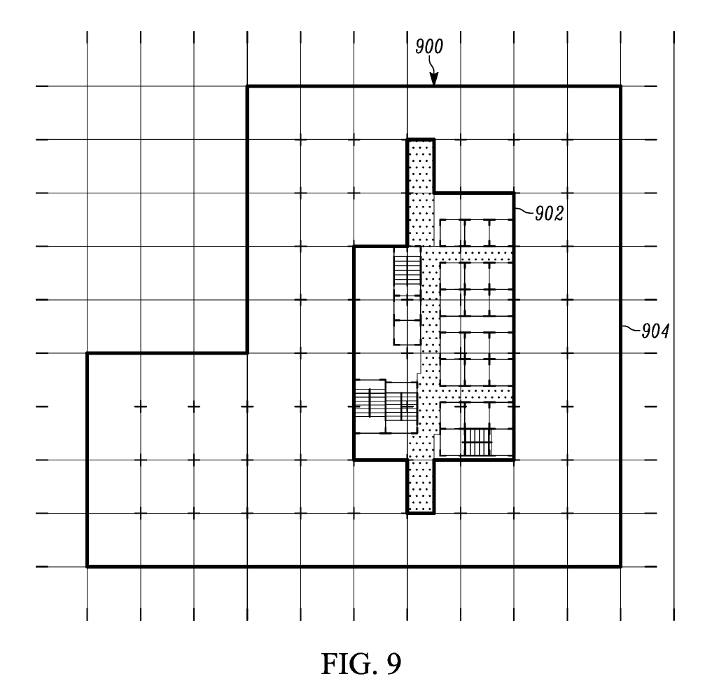

In an embodiment, building shell attributes include the dimensions and/or location of a core area and/or a placeable area. Building shell attributes can further include the dimensions and/or location of bays within the floor plan layout. In an embodiment, a bay is a fixed sized rectangle that is defined by the steel frame (e.g., an area defined by a pair of parallel girders and a pair of parallel beams) of a building that forms the structural support of the building. Typical bays include rectangles with sides in the range of 10-70 feet with sides in the range of 20-40 feet being common. Although bays are typically rectangles, other shaped bays are possible. FIG. 9 is an illustration of a building shell 900. In the illustration, the floor plan is made of a core area 902 and a placeable area 904. In an embodiment, the floor plan is placed in a coordinate grid such that the core area and placeable area can be identified by coordinate ranges. In an embodiment, the core area includes features of a floor plan layout that cannot be moved. For example, the core area, as illustrated, includes several stair cases and support walls that cannot be moved. The placeable area is the area in which the selected tiles can be placed. In an embodiment, cells of the coordinate grid represent bays.

Layout Generator

As described above with reference to FIG. 2, the selected tiles can be passed as an input to the layout generator (216, FIG. 2) along with the building shell. In an embodiment, the layout generator can be implemented to determine a placement of the set of tiles as a function of tile attributes of the selected tiles and building shell attributes by using a constraint programming solver similar to the tile selector. In an embodiment, the selected tiles, building shell, and other inputs can be passed to the constraint programming solver using a constraint programming language such as MiniZinc. The other inputs passed to the constraint programming solver may include known parameters, unknown parameters, constraints, and tiling rules. Known parameters may include the selected tiles and the dimensions of the building shell, while unknown parameters can include the position and orientation of the selected tiles within the floor plan layout, constraints can include limits on where and how many tiles can be placed within the floor plan layout, and tiling rules can include additional constraints on the solution of the constraint programming solver. For example, a tiling rule may state that certain tiles are to be placed along the building core or along the building shell. Another tiling rule may state that certain tiles form “triplets” and define circulation patterns (e.g., form a corner) for the triplets.

The constraint programming solver of the layout generator (216, FIG. 2) receives the above-described inputs and generates a floor plan layout. In an embodiment, the Layout Generator engine generates the floor plan layout as a function of tile attributes of the selected tiles and building shell attributes. Tile attributes can include physical dimensions (e.g., a number of bays a tile occupies) as well as other placement requirements (e.g., a tile with the breakroom should be near a tile with the storage). Building shell attributes can include the physical dimensions of the building shell. The Layout Generator engine can be configured to solve for a placement of the selected tiles within the building shell such that the selected tiles do not overlap while the other placement requirements are satisfied as well (e.g., by defining constraints in code for the constraint programming solver). The solution can then be output graphically and rendered in a modelling program such as Sketchup or can be output in code for importing into other programs or tools. In an embodiment, the Layout Generator engine can be configured to output every possible solution or just a single possible solution. The solution can be output as, for example, a 2-D drawing or as a 3-D model.

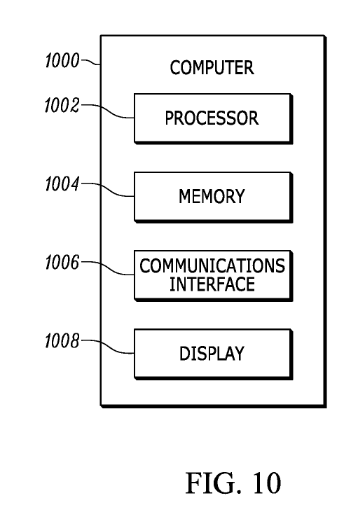

FIG. 10 depicts a computer 1000 that includes a processor 1002, memory 1004, a communications interface 1006, and a display 1008. The processor may include a multifunction processor and/or an application-specific processor. Examples of processors include the PowerPC™ family of processors by IBM and the x86 family of processors by Intel such as the Xeon™ family of processors and the Intel X5650 processor. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a non-transitory computer-readable storage medium for execution by a computer. As an example, an embodiment of a non-transitory computer-readable storage medium includes a computer useable storage medium configured to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An interior test fit system for automatically creating floor plan layouts using a computer having a memory, a central processing unit, and a display, the memory containing instructions that, when executed by the central processing unit, perform steps comprising:
obtaining client parameters, a room library, and a tile library as inputs;
determining a set of selected rooms from the room library, the set defined as a function of room contents and client parameters;
determining a set of selected tiles from the tile library, the set defined as a function of tile designs and the room attributes of the set of selected room; and
determining a placement of the set of tiles within a floor plan layout, the placement defined as a function of tile attributes of the selected tiles and building shell attributes.

2. The interior test fit system of claim 1, wherein client parameters define a percentage of the floor plan layout to be occupied by at least one mode.

3. The interior test fit system of claim 1, wherein the function of room contents and client parameters is a function such that the total percentage of area in the set of selected rooms allocated to at least one mode is equal to or greater than the total percentage of floor plan area to be allocated to the at least one mode as defined by the client parameters.

4. The interior test fit system of claim 1, wherein the function of tile designs and the room attributes of the set of selected rooms is a function such that:
all of the rooms in the space program can be placed within tiles in the set of selected tiles given the tile designs of the selected tiles; and
the selected tiles can be arranged in a manner which satisfies circulation constraints.

5. The interior test fit system of claim 1, wherein the function of tile attributes of the selected tiles and building shell attributes is a function such that the selected tiles do not overlap while placement requirements are satisfied.

6. A method for automatically creating floor plan layouts, the method comprising:
obtaining client parameters, a room library, and a tile library as inputs;
determining a set of selected rooms from the room library, the set defined as a function of room contents and client parameters;
determining a set of selected tiles from the tile library, the set defined as a function of tile designs and the room attributes of the set of selected room; and
determining a placement of the set of tiles within a floor plan layout, the placement defined as a function of tile attributes of the selected tiles and building shell attributes.

7. The method of claim 6, wherein obtaining client parameters comprises defining a percentage of the floor plan layout to be occupied by at least one mode.

8. The method of claim 6, wherein the function of room contents and client parameters is a function such that the total percentage of area in the set of selected rooms allocated to at least one mode is equal to or greater than the total percentage of floor plan area to be allocated to the at least one mode as defined by the client parameters.

9. The method of claim 6, wherein the function of tile designs and the room attributes of the set of selected rooms is a function such that:
all of the rooms in the space program can be placed within tiles in the set of selected tiles given the tile designs of the selected tiles; and
the selected tiles can be arranged in a manner which satisfies circulation constraints.

10. The method of claim 6, wherein the function of tile attributes of the selected tiles and building shell attributes is a function such that the selected tiles do not overlap while placement requirements are satisfied.

11. A non-transitory computer-readable storage medium comprising instructions that, when executed by a computer, cause the computer to perform steps for creating floor plan layouts, the steps comprising:
obtaining client parameters, a room library, and a tile library as inputs;
determining a set of selected rooms from the room library, the set defined as a function of room contents and client parameters;
determining a set of selected tiles from the tile library, the set defined as a function of tile designs and the room attributes of the set of selected room; and
determining a placement of the set of tiles within a floor plan layout, the placement defined as a function of tile attributes of the selected tiles and building shell attributes.

12. The non-transitory computer-readable storage medium of claim 11, wherein obtaining client parameters comprises defining a percentage of the floor plan layout to be occupied by at least one mode.

13. The non-transitory computer-readable storage medium of claim 11, wherein the function of room contents and client parameters is a function such that the total percentage of area in the set of selected rooms allocated to at least one mode is equal to or greater than the total percentage of floor plan area to be allocated to the at least one mode as defined by the client parameters.

14. The non-transitory computer-readable storage medium of claim 11, wherein the function of tile designs and the room attributes of the set of selected rooms is a function such that:
all of the rooms in the space program can be placed within tiles in the set of selected tiles given the tile designs of the selected tiles; and
the selected tiles can be arranged in a manner which satisfies circulation constraints.

15. The non-transitory computer-readable storage medium of claim 11, wherein the function of tile attributes of the selected tiles and building shell attributes is a function such that the selected tiles do not overlap while placement requirements are satisfied.
